(19) United States
(12) Patent Application Publication
(10) Pub. No.: US 2023/0312333 A1
(43) Pub. Date: Oct. 5, 2023

(54) MOISTURE WICKING AND ABSORBING SADDLE PAD OR PAD FOR SADDLE PAD

(71) Applicant: Zephyros, Inc., Romeo, MI (US)

(72) Inventors: Christophe Chaut, Molsheim (FR); Mike Nieder, Holtzheim (FR); Matthias Fuchs, Fegersheim (FR); Marc Engel, Lingolsheim (FR); Greg Thompson, Simpsonville, SC (US)

(21) Appl. No.: 18/024,387

(22) PCT Filed: Oct. 5, 2021
(86) PCT No.: PCT/US2021/053524

§ 371 Date: Mar. 2, 2023

Related U.S. Application Data
(60) Provisional application No. 63/087,479, filed on Oct. 5, 2020.

(51) Int. Cl. B68C 1/12; B32B 5/02; B32B 5/26; B32B 3/30; B32B 3/04

(52) U.S. Cl. CPC B68C 1/12; B32B 5/022; B32B 5/265; B32B 3/30; B32B 3/04; B32B 2307/726; B32B 2307/724; B32B 2307/56; B32B 2307/7265; B32B 2307/722; B32B 2307/718; B32B 2307/7376; B32B 2262/02; B32B 2571/00

(57) ABSTRACT

An article to be positioned between a rideable animal, such as an equine animal, and a saddle for absorbing and/or wicking perspiration and providing cushioning. The article includes a fibrous layer having generally vertically oriented fibers. The article is a breathable material. The article may be a saddle pad or an insert for a saddle pad.

### CLAIM OF BENEFIT OF FILING DATE

This application claims the benefit of U.S. Provisional Application No. 63/087,479, filed Oct. 5, 2020, the contents of which are hereby incorporated by reference in their entireties.

### FIELD

The present teachings generally relate to a material for providing moisture wicking and absorption, and more particularly, to a moisture wicking and absorbing saddle pad.

### BACKGROUND

A saddle pad is often used between a saddle and a horse. The saddle pad may improve a saddle's fit on the horse. The saddle pad may provide cushioning between the saddle and the horse to increase comfort and support to the horse, rider, or both. The saddle pad may also help to keep the saddle clean, as otherwise the saddle would be situated directly on the horse, thereby collecting sweat from the horse and being in direct contact with any dirt or debris on the horse.

Saddle pads come in a variety of shapes, sizes, thicknesses, and materials. However, existing saddle pads also have disadvantages. Some saddle pads may slide or bunch, causing discomfort to the horse or causing the saddle to shift. Some saddle pads are made from materials that can retain heat on a horse's back, thereby increasing perspiration for the horse. Typical materials used for saddle pads include closed cell foams, cross-lapped felts, or materials having a horizontal fiber orientation. However, while these materials may absorb moisture, they often have poor breathability, resulting in the absorbed moisture remaining in the material, promoting the growth of fungi or bacteria and causing odor. These materials may be heavy and hot for a horse, thereby causing and accumulating more sweat. Additionally, these materials tend to have poor resiliency in applications requiring heightened stress on the material. These materials are often difficult to clean and may even gain weight over time due to the building up of moisture, mildew, and the like. Some saddle pads are not easily washable, as they may include materials that degrade or do not adequately dry upon repeated exposure to cleaning materials or moisture. Some saddle pads are formed of materials chosen for their shock-absorbing characteristics, such as neoprene pads; however, these materials may hold heat or wear faster than other materials. Some saddle pads, such as those based on gel technology, are not breathable and have low pressure spread once the gel is squeezed in the pad.

Additionally, a horse's weight may fluctuate depending on the season and depending on the horse's age. A saddle may fit a horse differently in warmer months than in colder months. As horses age, their bone structure changes and muscles will develop or grow from use and work. Older horses may gain weight in different places than younger horses or may lose muscle mass. As saddles are costly, it is desirable to reduce the number of saddles required for a horse during different seasons or different life stages. Therefore, saddle pads may be used to tailor the fit of the saddle for many years and many seasons.

Therefore, it is desirable to provide a saddle pad or a portion of a saddle pad, such as an insert for use with a saddle pad, that is breathable, wicking, cooling, cushioning, resilient, able to withstand repeated use, durable, washable, or a combination thereof. It is desirable to provide a saddle pad that allows for customization of the saddle fit based on normal variations of a horse's body during the year and during its lifetime. It is desirable to provide a saddle pad that distributes pressure to increase comfort for the horse, rider, or both.

Therefore, there is a need for a product that provides cushioning while providing moisture absorption and wicking properties. There is a need for a material that is breathable. There is a need for a material that provides antimicrobial, antifungal, anti-odor, or mildew resistant properties. There is a need for a product that provides the ability to customize the fit of a saddle or enhance the fit of a saddle, without having to buy or obtain a new saddle depending on the age of the horse or the season.

### SUMMARY

The present teachings meet one or more of the above needs by the improved devices and methods described herein. The present teachings include a material that may provide cushioning, comfort, the ability to clean, or a combination thereof. The present teachings include a material that provides structural resiliency; comfortable product feel; moisture wicking; odor reduction or inhibition; cooling effect to the horse; quick drying properties; cleanability and/or washability; durability; capability to be formed into three-dimensional shapes; pressure distribution; or a combination thereof.

The material provides comfortable cushioning with a combination of attributes to address both the need for padding between a saddle and a horse, and for a mechanism to wick sweat from the horse (e.g., the horse's back). The three-dimensional wicking structure works in combination with the saddle pad design to provide air flow to dry the sweat as it is pulled away from the horse's back. The material may be antimicrobial and eliminate odors caused by sweat while also being machine washable to keep the product fresh and reusable.

### BRIEF DESCRIPTION OF THE DRAWINGS

FIG. 1 is an exemplary saddle pad in accordance with the present teachings.

FIG. 2 is an exemplary layered material in accordance with the present teachings.

FIG. 3 is an exemplary saddle pad in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

While discussed in the context of horseback riding, and while horses are specifically referenced, it is possible for the materials described herein to be used with other riding animals, and the present teachings encompass materials to be used with these other animals. For example, but not limiting, the materials may be used with equines such as horses, donkeys, and mules; bovines such as cattle, water buffalo, and yak; or even animals such as elephants, reindeer, and camels. Also, while referred to herein as a saddle pad, the present teachings also contemplate horse blankets, inserts adapted to be inserted into a portion of a saddle pad or horse blanket, or even an insert adapted to be secured to the underside of a saddle.

The saddle pad of the present teachings may be adapted to be located on the back of a rideable animal, such as a horse. The saddle pad may be of sufficient shape and flexibility to be draped over at least a portion of the animal. The saddle pad may have a top portion when the material is shaped or draped over the animal. The saddle pad may have generally opposing flaps adapted to flank the body of the horse.

The saddle pad may have sufficient length along the top (i.e., the portion adapted to be located along the back of the horse or other animal) to provide comfort to the horse (e.g., by cushioning, wicking, cooling, or a combination thereof), to distribute the pressure from a saddle and/or rider, to completely cover the area upon which the saddle will rest (e.g., so no portion of the saddle directly contacts the horse), or a combination thereof. The layered product may have sufficient length at the longest portion of the flap to provide comfort (e.g., by cushioning, wicking, cooling, or a combination thereof), to distribute the pressure from a saddle and/or rider, to completely cover the area upon which the saddle, stirrup, stirrup iron, or any combination will rest (e.g., so no portion of the saddle directly contacts the horse), or a combination thereof.

The saddle pad may be a generally flat, flexible material, thereby allowing the material to be draped over the horse. The saddle pad may be capable of laying generally flat when not in use or not positioned on a horse. The saddle pad may be shaped, and retain its shape, even when not positioned on a horse. The saddle pad may generally have the shape of an upside-down U (e.g., when viewing from the front or rear). The saddle pad may be shaped so the interior of the saddle pad generally matches the contours of the horse's back or area upon which the saddle is intended to be situated. The saddle pad may be shaped so the exterior of the saddle pad generally matches the contours of the underside of the saddle. The flaps of the saddle pad may be generally symmetrical (e.g., where the top of the saddle pad is the centerline). Shaping may be performed, to form the saddle pad into a three-dimensional shape, for example, by thermoforming and/or molding. Prior to forming the three-dimensional shape, the saddle pad or materials thereof may have one or more cutouts, scored portions, thinned portions, or other features that allow the material to be folded, bent, curved, thermoformed, molded, or the like, into the desired shape without excess material.

The saddle pad may have one or more features that allow the saddle pad to drape over the back of a horse without wrinkling or bunching of excess material. The saddle pad may have one or more features that provide flexibility to the saddle pad. The saddle pad may have one or more features that encourage or facilitate flexibility at certain parts of the saddle pad. For example, the saddle pad may have one or more cutouts or contours. The cutout or contour may be located in an area where the saddle pad is intended to curve or be positioned on the horse. The cutout or contour may assist in preventing slippage of the saddle pad on the back of the horse. The cutout or contour may assist in providing proper positioning of the saddle pad on the back of the horse. The cutout or contour may be generally centrally located along one or more long edges of the saddle pad, such that the saddle pad is able to be positioned on the back of the horse with opposing sides of the saddle pad flanking the horse. For example, the saddle pad may have generally opposing cutouts or contours along the long edges of the saddle pad to provide flexibility at the center of the saddle pad. The cutout or contour may allow for the saddle pad to lay generally flat along the back of the horse, without bunching, wrinkling, or other deformation (e.g., of excess material).

The saddle pad may be entirely formed from a layered material as described herein. The saddle pad may include portions formed from a layered material as described herein. For example, the saddle pad may include pockets or openings adapted to receive an insert formed from the layered material as described herein.

The layered materials may provide additional benefits such as compression resilience and puncture resistance, protection (e.g., by providing cushioning), breathability, padding, pressure relief, pressure distribution, moisture transference (e.g., moisture is moved from a surface of a user through the material), odor inhibition, cooling effects, insulative effects, or a combination thereof. The material may be shaped to fit the area to which it will be worn or used. For example, the material may be shaped as a saddle pad or horse blanket that is draped over the back of a horse. The material may have a shape that is generally complementary to the area of the horse upon which it is intended to be positioned. The material may be shaped as an insert for insertion into a pocket of a saddle pad or horse blanket. The material may have one or more contours to enhance stability of the saddle pad on the horse, enhance stability of the saddle on the horse, or both. The material may be soft feeling, lightweight, washable, reusable, or a combination thereof.

The material may provide enhanced pressure distribution or pressure relief for the animal. Pressure relief or pressure distribution may be enhanced as compared to a traditional saddle pad or horse blanket. Testing may be performed using a pressure acquisition blanket, a saddle pad, and a saddle. Upon testing, the present material has improved and more uniform pressure distribution as compared with existing materials. The present material reduces or avoids pressure points. The load of a saddle and/or rider is spread over a wider surface as compared with traditional saddle pads. The material of the present teachings may be of similar shape or dimensions as a traditional saddle pad but is lighter weight than traditional saddle pads.

The material may be a layered material having a plurality of layers adapted to include one or more of the above characteristics. The material may include one or more fibrous layers, where the fibers are arranged in a generally vertical orientation (e.g., vertical in the thickness direction). The fibers may be in a generally vertical orientation when in an uncompressed state and/or prior to undergoing compression, sealing, localized compression, stitching, or the like. The material may include one or more additional layers. These additional layers may be or may include moisture wicking layers. For example, the layered material may include a moisture transport layer (e.g., a layer that contacts the source of moisture). The material may include one or more outer layers on an opposing surface of the one or more fibrous layers. The outer layer may be a moisture wicking layer. One or more of the layers, or the entire material itself, may be flexible, stretchable, breathable, or a combination thereof.

The layered material may have a designated interior layer (e.g., an interior wicking layer) adapted to contact the animal. The layered material may have a designated exterior layer (e.g., an exterior wicking layer) adapted to contact a saddle, adapted to face away from the animal, or both. A fibrous layer may be located therebetween.

While described herein as a layered material, it is contemplated that one or more sides of the fibrous layer, or at least a portion of a side of the fibrous layer, may be free of any facing layers, wicking layers, scrims, or the like. While referred to as “layers,” it is contemplated that this includes discrete layers or portions within one or more materials. For example, a two layer material may include two discrete layers or a single material having two different portions. The layered material may include one or more layers. The fibrous layer, alone or in combination with other layers, may form an insert adapted to be held in place on or located within a pocket or other area of a saddle pad. It is contemplated that the area where the insert is to be secured may include one or more additional layers that may provide wicking or act as a facing or protective layer for the fibrous layer. For example, the material defining the pocket may act to sandwich the fibrous layer. The material defining the pocket may act as a wicking or moisture contact layer.

The layered material may include one or more fibrous layers. The fibrous layers may transfer moisture from one or more abutting layers. The fibrous layers may absorb moisture directly from the source of the moisture. The fibrous layers may transfer moisture to one or more abutting layers. The fibrous layers may provide cushioning or protection. The fibrous layers may provide such cushioning or protection at a light weight.

One or more of the fibrous layers may have a high loft (or thickness) at least in part due to the orientation of the fibers (e.g., oriented generally transverse to the longitudinal axis of the layer) of the layer and/or the methods of forming the layer. The fibrous layer may exhibit good resilience and/or compression resistance. The fibrous layer may be resistant to puncturing. The fibrous layer, due to factors such as, but not limited to, unique fibers, surfaces, physical modifications to the three-dimensional structure (e.g., via processing), orientation of fibers, or a combination thereof, may exhibit good moisture transfer and/or absorption characteristics versus traditional materials.

The fibrous layer may be adjusted based on the desired properties. The fibrous layer may be tuned to provide a desired weight, thickness, compression resistance, or other physical attributes. The fibrous layer may be tuned to provide a desired moisture absorption or moisture transfer rate. The fibrous layer may be tuned to provide a desired drying rate. The fibrous layer may be formed from nonwoven fibers. The fibrous layer may be a nonwoven structure. The fibrous layer may be a lofted material. The fibrous layer may be thermoformable so that the layers may be molded or otherwise manufactured into a desired shape to meet one or more application requirements.

The fibrous layer may have a generally uniform distribution of fibers. The fibrous layer may have a generally uniform density throughout the thickness of the material. The fibrous layer may have a varying structure through the thickness. The fibrous layer may have a gradient structure where the material gradually becomes more rigid. For example, the fibrous layer may have a softer interior surface (i.e., facing the animal), and a harder external surface (i.e., facing away from the animal or facing the saddle). The gradient structure may further enhance moisture evaporation rate on the external side.

The drying rate or rate of evaporation for the fibrous layer (or the layered material as a whole) may be improved over other products, such as foams or cross-lapped products. This may be due, at least in part, to factors such as shape, porosity, permeability, fiber orientation of the fibrous layer, orientation of the loops of the fibrous layer, areas of localized compression or stitching or texture of one or more layers to create channels to promote air flow (e.g., air flow between the saddle and the material, air flow between the horse and the material, or both), or a combination thereof. The fibrous layer may have a high porosity, high percentage of open areas, high permeability, or combination thereof. This may allow for air to flow more efficiently through the material, as opposed to a more tortuous material such as a foam or cross-lapped material. The fibrous layer may have a porosity of about 90% or greater, about 96% or greater, about 97% or greater, or about 98% or greater or about 99% or greater. The porosity of the fibrous layer may be less than 100%.

The fibrous layer may be permeable. The fibrous layer may be porous. The fibrous layer may have pores. The pores may be formed from interstitial spaces between the fibers and/or the shape (e.g., by having a multi-lobal or deep-grooved cross-sectional fiber) of the fibers. The pores may extend throughout the entire thickness of the fibrous layer. The pores may extend through a portion of the thickness of the fibrous layer. The pores and/or the vertical orientation of the fibers may create a capillary effect or chimney effect for absorbing moisture or removing moisture from one surface and transferring to another area (e.g., to another moisture wicking layer, to another portion of the fibrous layer, and the like). For example, the fibrous layer may push and/or pull the moisture from a first surface of the fibrous layer to an opposing second surface of the fibrous layer through the thickness of the fibrous layer. Capillary effect, or capillary action, is the ascension of liquids through a tube, pore, cylinder, or permeable substance due to adhesive and cohesive forces interacting between the liquid and the surface. The diameter of the pores or channels defined by the fibers (e.g., forming a capillary) for movement of liquid may be selected based on the thickness of the material through which the liquid must travel. A thinner diameter capillary or channel may see the liquid rise higher than liquid in a larger diameter capillary or channel due to capillary action because of adhesive forces.

The ability of the fibrous layer to pull or push moisture through the layer may be, at least in part, due to the geometries of the fibers. The fibers may have a cross-section that is substantially circular or rounded. The fibers may have a cross-section that has one or more curved portions. The fibers may have a cross-section that is generally oval or elliptical. The fibers may have a cross-section that is non-circular. Such non-circular cross-sections may create additional tubes or capillaries within which the moisture can be transferred. For example, the fibers may have geometries with a multi-lobal cross-section (e.g., having 3 lobes or more, having 4 lobes or more, or having 10 lobes or more). The fibers may have a cross-section with deep grooves. The fibers may have a substantially “Y”-shaped cross-section. The fibers may have a polygonal cross-section (e.g., triangular, square, rectangular, hexagonal, and the like). The fibers may have a star shaped cross-section. The fibers may be serrated. The fibers may have one or more branched structures extending therefrom. The fibers may be fibrillated. The fibers may have a cross-section that is a nonuniform shape, kidney bean shape, dog bone shape, freeform shape, organic shape, amorphous shape, or a combination thereof. The fibers may be substantially straight or linear, hooked, bent, irregularly shaped (e.g., no uniform shape), or a combination thereof. The fibers may include one or more voids extending through a length or thickness of the fibers. The fibers may have a substantially hollow shape. The fibers may be generally solid. The shape of the fibers may define capillaries or channels through which moisture can travel (e.g., from one side of the fibrous layer to an opposing side of the fibrous layer).

The fibers that make up the fibrous layers (or any other layer of the material) may have an average linear mass density of about 0.5 denier or greater, about 1 denier or greater, or about 5 denier or greater. The material fibers that make up the fibrous layers may have an average linear mass density of about 25 denier or less, about 20 denier or less, or about 15 denier or less. Fibers may be chosen based on considerations such as cost, resiliency, desired moisture absorption/resistance, or the like. For example, a coarser blend of fibers (e.g., a blend of fibers having an average denier of about 12 denier) may help provide resiliency to the fibrous layers. A finer blend (e.g., having a denier of about 10 denier or less or about 5 denier or less) may be used, for example, if a softer material is required to contact the animal, for example. The fibers may have a staple length of about 1.5 millimeters or greater, or even about 70 millimeters or greater (e.g., for carded fibrous webs). For example, the length of the fibers may be between about 30 millimeters and about 65 millimeters. The fibers may have an average or common length of about 50 to 60 millimeters staple length, or any length typical of those used in fiber carding processes. Short fibers may be used (e.g., alone or in combination with other fibers) in any nonwoven processes. For example, some or all of the fibers may be a powder-like consistency (e.g., with a fiber length of about 3 millimeters or less, about 2 millimeters or less, or even smaller, such as about 200 microns or greater or about 500 microns or greater). Fibers of differing lengths may be combined to provide desired properties. The fiber length may vary depending on the application; the moisture properties desired; the type, dimensions and/or properties of the fibrous material (e.g., density, porosity, desired air flow resistance, thickness, size, shape, and the like of the fibrous layer and/or any other layers of the layered material); or any combination thereof. The addition of shorter fibers, alone or in combination with longer fibers, may provide for more effective packing of the fibers, which may allow pore size to be more readily controlled in order to achieve desirable characteristics (e.g., moisture interaction characteristics).

The fibrous layer (or any other layer of the material) may include fibers blended with the inorganic fibers. The fibrous layer may include natural, manufactured, or synthetic fibers. Suitable natural fibers may include cotton, jute, wool, flax, silk, cellulose, glass, and ceramic fibers. The fibrous layer may include eco-fibers, such as bamboo fibers or eucalyptus fibers. Suitable manufactured fibers may include those formed from cellulose or protein. Suitable synthetic fibers may include polyester, polypropylene, polyethylene, Nylon, aramid, imide, acrylate fibers, or combination thereof. The fibrous layer material may comprise polyester fibers, such as polybutylene terephthalate (PBT), polyethylene terephthalate (PET), polytrimethylene terephthalate (PTT), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), polyethersulfone (PES), or other polymeric fibers. The fibers may be selected for their melting and/or softening temperatures. The fibers may include mineral or ceramic fibers. The fibers may be or may include elastomeric fibers. Elastomeric fibers may provide cushioning performance and/or compressibility and recovery properties. Exemplary elastomeric fibers include elastic bicomponent PET, PBT, PTT, or a combination thereof. The fibers may be formed of any material that is capable of being carded and lapped into a three-dimensional structure. The fibers may be 100% virgin fibers, or may contain fibers regenerated from postconsumer waste (for example, up to about 90% fibers regenerated from postconsumer waste or even up to 100% fibers regenerated from postconsumer waste). The fibers may have or may provide improved moisture absorption or moisture resistance characteristics, or both.

The fibers may have particles embedded therein. The particles may act to remove moisture in the vapor stage (e.g., before becoming liquid). The particles may be embedded through an extrusion process. These particles may provide breathability and/or waterproofing properties to the fibrous layer. The particles present in the fibers may increase the surface area of the fiber by 50% or more, about 100% or more, by 200% or more, or by 500% or more as compared with a fiber that is free of embedded particles. The particles may increase the surface area of the fiber by about 1200% or less, about 1000% or less, or about 900% or less. The high surface area of the fiber may provide high adsorption properties. These fibers may assist in providing heating and/or cooling. These fibers may provide odor control, humidity control (e.g., body humidity control), or both. The particles may assist in removing or driving moisture vapor away from the source (e.g., through the layer). Embedded particles may include, but are not limited to, wood, shells (e.g., fruit and/or nut shells, such as coconut shells or fibers thereon, hazelnut shells), activated carbon, sand (e.g., volcanic sand), or a combination thereof. For example, the fiber may be a PET fiber extruded with active carbon and/or volcanic sand.

The fibers may be 100% virgin fibers or less. The fibers may include fibers regenerated from postconsumer waste (for example, up to about 90% fibers regenerated from postconsumer waste or even up to 100% fibers regenerated from postconsumer waste). The fibers may have or may provide improved thermal insulation properties. The fibers may have relatively low thermal conductivity. Such fibers may be useful for retaining heat or slowing the rate of heat transfer (e.g., to keep a user or wearer warm). The fibers may have or may provide high thermal conductivity, thereby increasing the rate of heat transfer. Such fibers may be useful for extracting heat from the surface of the source of moisture (e.g., to cool a user or wearer). The fibers may have geometries that are non-circular or non-cylindrical. The fibrous layer may include or contain engineered aerogel structures to impart additional thermal insulating benefits. The fibrous layer may include or be enriched with pyrolized organic bamboo additives.

The fibers, or at least a portion of the fibers, making up one or more layers of the material may include a hydrophilic finish or coating. The hydrophilic finish or coating may create or improve the capillary effect of drawing the moisture into the capillaries or channels formed by the fibers or improve absorption of the material by drawing the moisture away from the user. The fibers, or at least a portion of the fibers, may be super absorbing fibers (SAF). The SAF may be formed of a cellulose material or a synthetic polymeric material, for example. The SAF may be in a blend with other fibers. The SAF may be present in an amount of about 60% of the blend by weight or less, about 50% by weight or less, or about 40% by weight or less. The SAF may be present in an amount greater than 0%, about 1% by weight or greater, or about 5% by weight or greater. The SAF may pull moisture into the material cross-section, where it may evaporate.

One or more fibrous layers (or any other layer of the material) may include a plurality of bi-component fibers. The bi-component fibers may be a thermoplastic lower melt bi-component fiber. The bi-component fibers may have a lower melting temperature than the other fibers within the mixture (e.g., a lower melting temperature than common or staple fibers). The bi-component fibers may be air laid or mechanically carded, lapped, and fused in space as a network so that the layered material may have structure and body and can be handled, laminated, fabricated, installed as a cut or molded part, or the like to provide desired properties. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers.

The fibrous layer (or any other layer of the layered material) may include a binder or binder fibers. Binder may be present in the fibrous layer in an amount of about 100 percent by weight or less, about 80 percent by weight or less, about 60 percent by weight or less, about 50 percent by weight or less, about 40 percent by weight or less, about 30 percent by weight or less, about 25 percent by weight or less, or about 15 percent by weight or less. The fibrous layer may be substantially free of binder. The fibrous layer may be entirely free of binder. While referred to herein as fibers, it is also contemplated that the binder could be generally powder-like, spherical, or any shape capable of being received within interstitial spaces between other fibers and capable of binding the fibrous layer together. The binder may have a softening and/or melting temperature of about 70° C. or greater, about 100° C. or greater, about 110° C. or greater, about 130° C. or greater, 180° C. or greater, about 200° C. or greater, about 225° C. or greater, about 230° C. or greater, or even about 250° C. or greater. For example, the binder may have a softening and/or melting temperature between about 70° C. and about 250° C. (with any range therein being contemplated). The fibers may be high-temperature thermoplastic materials. The fibers may include one or more of polyamideimide (PAI); high-performance polyamide (HPPA), such as Nylons; polyimide (PI); polyketone; polysulfone derivatives; polycyclohexane dimethyl-terephthalate (PCT); fluoropolymers; polyetherimide (PEI); polybenzimidazole (PBI); polyethylene terephthalate (PET); polybutylene terephthalate (PBT); polyphenylene sulfide; syndiotactic polystyrene; polyetherether ketone (PEEK); polyphenylene sulfide (PPS), polyether imide (PEI); and the like. The fibrous layer may include polyacrylate and/or epoxy (e.g., thermoset and/or thermoplastic type) fibers. The fibrous layer may include a multi-binder system. The fibrous layer may include one or more elastomeric fiber materials acting as a binder. The fibrous layer may include one or more sacrificial binder materials and/or binder materials having a lower melting temperature than other fibers within the layer.

The fibers and binders discussed herein in the context of the fibrous layers may also be used to form any other layer of the layered material.

The fibers forming the one or more fibrous layers may be formed into a nonwoven web using nonwoven processes including, for example, blending fibers, carding, lapping, air laying, mechanical formation, or a combination thereof. Through these processes, the fibers may be oriented in a generally vertical direction or near-vertical direction (e.g., in a direction generally perpendicular to the longitudinal axis of the fibrous layer). For example, the fibrous layers may include a carded and lapped material. When carded, the fibers may be arranged generally in the machine direction. When lapped, the fibers may be arranged to generally follow a generally sinusoidal shape. The fibers may be generally vertical (e.g., extending between surfaces in the thickness direction) between loops of the lapped structure. The fibers may be generally curved at the looped portions. The fibers may be opened and blended using conventional processes. The resulting structure formed may be a lofted fibrous layer. The lofted fibrous layer may be engineered for optimum weight, thickness, physical attributes, thermal conductivity, insulation properties, moisture absorption, or a combination thereof.

One or more fibrous layers may be formed, at least in part, through a carding process. The carding process may separate tufts of material into individual fibers. During the carding process, the fibers may be aligned in substantially parallel orientation with each other and a carding machine may be used to produce the web.

A carded web may undergo a lapping process to produce the fibrous layers. The carded web may be rotary lapped, cross-lapped or vertically lapped, to form a voluminous or lofted nonwoven material. The carded web may be vertically lapped according to processes such as “Struto” or “V-Lap”, for example. This construction provides a web with relative high structural integrity in the direction of the thickness of the fibrous layers, thereby minimizing the probability of the web falling apart during application, or in use, and/or providing compression resistance to the layered material. Carding and lapping processes may create nonwoven fibrous layers that have good compression resistance through the vertical cross-section (e.g., through the thickness of the layered material) and may enable the production of lower mass fibrous layers, especially with lofting to a higher thickness without adding significant amounts of fiber to the matrix. It is contemplated that a small amount of hollow conjugate fiber (i.e., in a small percentage) may improve lofting capability and resiliency to improve moisture absorption, physical integrity, or both. Such an arrangement also provides the ability to achieve a low density web with a relatively low bulk density.

The lapping process may create a looped, sinusoidal, or undulated appearance of the fibers when viewed from its cross-section prior to any compression operation. The loops may have generally curved or rounded portions (e.g., as opposed to sharp creases from a traditional pleating operation). The frequency of the loops, or undulations may be varied during the lapping process. For example, having an increase in loops or undulations per area may increase the density and/or stiffness of the layer or layers of the material. Reducing the loops or undulations per area may increase the flexibility of the layer or layers and/or may decrease the density. The ability to vary the loop or undulation frequency during the lapping process may allow for properties of the material to be varied or controlled. It is contemplated that the loop or undulation frequency may be varied throughout the material. During the lapping process, the loop frequency may be dynamically controlled and/or adjusted. The adjustment may be made during the lapping of a layer of the material. For example, certain portions of the layer may have an increased frequency, while other portions of the layer or layers may have a frequency that is lower. The adjustment may be made during the lapping of different layers of the material. Different layers may be made to have different properties with different loop frequencies. For example, one layer may have a loop frequency that is greater than or less than another layer of the layered material.

In an exemplary fibrous layer, the carded web, with the fibers generally extending in the machine direction, may then undergo a lapping process, creating a series of loops or undulations (e.g., appearing as peaks and valleys when viewed from the side or a cross section). The loops (e.g., line extending across an entire peak or valley) may extend across the surface of the material generally perpendicularly to the longitudinal axis of the fibrous layers, generally perpendicularly to the machine direction, or both.

As an example, when the saddle pad is positioned on the back of a horse, the loops may run generally parallel to the spine of the horse, generally parallel to the longitudinal axis of the body of the horse, or both.

In another example, the loops may run generally perpendicular to the spine of the horse, generally perpendicular to the longitudinal axis of the body of the horse, generally parallel with the horse's legs, or a combination thereof.

The fibrous layers may be formed by an air laying process. This air laying process may be employed instead of carding and/or lapping. In an air laying process, fibers are dispersed into a fast moving air stream, and the fibers are then deposited from a suspended state onto a perforated screen to form a web. The deposition of the fibers may be performed by means of pressure or vacuum, for example. An air laid or mechanically formed web may be produced. The web may then be thermally bonded, air bonded, mechanically consolidated, the like, or combination thereof, to form a cohesive nonwoven fibrous layer. While air laying processes may provide a generally random orientation of fibers, there may be some fibers having an orientation that is generally in the vertical direction so that resiliency in the thickness direction of the material may be achieved.

During processing of the material, the fibrous layers may be compressed. Compression may occur during lamination, thermoforming in-situ, or the like. Compression may reduce thickness of the fibrous layers. The thickness may be reduced by 10% or more, about 25% or more, about 40% or more, or about 50% or more. The thickness may be reduced by about 80% or less, about 75% or less, about 67% or less, or about 60% or less. Upon compression, instead of a generally sinusoidal cross-section with generally straight segments between opposing loops, the segments between the loops may be generally C-shaped, S-shaped, Z-shaped, or otherwise curved, folded, or bent.

The layered material may include one or more acquisition layers, which may function to draw moisture from the source, from a layer directly adjacent, or both. The acquisition may be a facing layer. The acquisition layer may be an outer layer. The acquisition layer may be a wicking layer. The acquisition layer may be formed using any of the fibers and/or binders discussed herein with respect to the fibrous layer. One or more acquisition layers may be made from Lycra, polyester, polyethylene terephthalate, or a combination thereof.

An acquisition layer may include one or more moisture transport layers, which may serve to transport moisture from a source (e.g., a surface of the animal, a layer directly adjacent, another moist layer, such as an additional layer of the saddle pad if the layered material is an insert material) to the one or more fibrous layers. The one or more moisture transport layers may draw moisture from the source and distribute the moisture over a wider surface area to enhance absorption by other layers, to enhance evaporation or drying of the moisture, or both. One layer may serve as an acquisition layer, which may function to draw moisture from the source. Another layer may serve as a distribution layer, which may function to disperse moisture around the area of the layer and/or adjacent layers. These functions may instead be performed by a single layer.

The one or more moisture transport layers may be attached to one side of a fibrous layer. The one or more moisture transport layers may be adapted to abut or contact a surface that is the source of the moisture. For example, a moisture transport layer may be a contact surface for the animal's back. The moisture transport layer may facilitate movement of sweat or moisture from animal's back or hair or fur to the fibrous layer. The moisture transport layer may have a smooth-to-the-touch surface to provide a comfortable contact surface.

The layered material may include one or more facing layers. The one or more facing layers may be an outer layer (e.g., an outermost layer of the material). An outer layer may face the surface of the source of the moisture. An outer layer may face away from the surface of the source of the moisture. Outer layers may be located on opposing sides of the fibrous layers and/or on opposing sides of the entire layered material. An outer layer may act to take up moisture from the source of the moisture or take up moisture from a layer directly adjacent. One or more of the facing or outer layers may encourage evaporation or have quick drying properties. The one or more outer layers may be permeable or breathable to allow for air flow within the layer. The breathability or permeability may enhance the evaporation of the moisture, thereby allowing the layered material to dry. The outer layer may include perforations, apertures, voids, or openings to further encourage permeability and/or drying of the layer.

The layered material may include one or more wicking layers. The one or more wicking layers may be a facing or outer layer. The one or more wicking layers may be located within the layered material. The wicking layers may be formed from a nonwoven material, a woven material, a knit material, a meltblown material (e.g., of thermoplastic polyurethane), or the like. One or more wicking layers may be made from Lycra, polyester, polyethylene terephthalate, or a combination thereof.

One or more of the layers may draw moisture in vapor form away from the source. For example, one or more layers may pull perspiration vapor away from a body before the perspiration becomes liquid sweat.

It is further contemplated that one or more of the layers may be a non-wicking material formed by any of the fibers and/or binders discussed herein with respect to the fibrous layer. One or more of the wicking layers may be substituted by a non-wicking layer, such as a scrim, facing, mesh, or other permeable material.

In an exemplary layered material, an acquisition layer draws moisture from the animal's back and transports the moisture to the fibrous layer. The moisture is dispersed over an area by the acquisition layer, fibrous layer, or both. The moisture is guided to areas of increased air flow, such as the opposing side of the fibrous layer or an outer layer not covered by a saddle. The distribution of moisture through the material may be further guided by gravity (i.e., pulled downward) toward the edge of the flap of the saddle pad. As the animal moves, thereby increasing air flow to the exposed portions of the saddle pad or material, evaporation of the moisture occurs. As areas of the material dry due to evaporation, additional moisture is drawn to these areas, thereby increasing the rate of evaporation.

One or more fibrous layers, the fibers forming the fibrous layers, the resulting layered material, or a combination thereof, may be used to form a thermoformable layered material (which may be nonwoven), which indicates a material (e.g., nonwoven material) that may be formed with a broad range of densities and thicknesses and that contains a thermoplastic and/or thermoset binder. The thermoformable material may be heated and thermoformed into a specifically shaped thermoformed product. The layered material may have a varying thickness (and therefore a varied or non-planar profile) along the length of the material. Areas of lesser thickness may be adapted to provide controlled flexibility to the material, such as to provide an area with additional flexibility and elasticity, such as to form a stretchable compression article of clothing. The layered material may be shaped (e.g., by folding, bending, thermoforming, molding, and the like) to produce a shape generally matching a desired shape for a given application.

The layered material may be formed of a plurality of layers, including one or more wicking layers, (e.g., one or more moisture transport layers, one or more outer layers), one or more surface layers, one or more skin layers, and/or one or more fibrous layers, in any combination and in any order. The material may include two or more fibrous layers. The layered material may include one or more lofted layers, one or more wicking layers, or both. A skin layer may be formed by melting a portion of the layer by applying heat in such a way that only a portion of the layer, such as the top surface, melts and then hardens to form a generally smooth surface. A scrim may be applied or secured to one or more fibrous layers. The layered material may include a plurality of layers, some or all of which serve different functions or provide different properties to the layered material. The ability to combine layers having different properties may allow the layered material to be customized based on the application. For example, the layers may be combined so that the layered material is an article of clothing or padding that is moisture wicking, moisture transferring, insulative, cooling, has low drying times, or a combination thereof. The layers may be combined so that the layered material provides cushioning with high resilience.

A coating may be applied to form one or more surface layers on the fibrous layers. The coating may improve one or more characteristics of the layered material. For example, the surface layers may be anti-microbial, anti-fungal, have high infrared reflectance, moisture resistant, mildew resistant, or a combination thereof. The surface layers may be an extension of the fibrous layers or wicking layers. At least some of the surface layers may be metalized. For example, fibers along an outer surface of the fibrous layers or wicking layers may form the surface layers. Metallization processes can be performed by depositing metal atoms onto the fibers of the surface layers. As an example, metallization may be established by applying a layer of silver atoms to the surface layers. Metalizing may be performed prior to the application of any additional layers to the fibrous layers.

The metallization may provide a desired reflectivity or emissivity. The surface layers may be about 50% IR reflective or more, about 65% IR reflective or more, or about 80% IR reflective or more. The surface layers may be about 100% IR reflective or less, about 99% IR reflective or less, or about 98% IR reflective or less. For example, the emissivity range may be about 0.01 or more or about 0.20 or less, or 99% to about 80% IR reflective, respectively. Emissivity may change over time as oil, dirt, degradation, and the like may impact the fibers in the application.

Other coatings may be applied to the fibrous layers to form the surface layers, metallized or not, to achieve desired properties. Oleophobic and/or hydrophobic treatments may be added. Flame retardants may be added. A corrosion resistant coating may be applied to the metalized fibers to reduce or protect the metal (e.g., aluminum) from oxidizing and/or losing reflectivity. IR reflective coatings not based on metallization technology may be added. Anti-microbial or anti-fungal coatings may be applied. For example, silver powder or other antimicrobial nano-powders can be added into a portion of the fibrous layers to form the surface layers.

One or more layers may be a porous bulk absorber (e.g., a lofted porous bulk absorber formed by a carding and/or lapping process). One or more layers may be formed by air laying. The layered material may be formed into a generally flat sheet. The layered material (e.g., as a sheet) may be capable of being rolled into a roll. The layered material may be a continuous material so that longer lengths can be employed in a single piece. The layered material (or one or more of the layers of the layered material) may be an engineered 3D structure. It is clear from these potential layers that there is great flexibility in creating a material that meets the specific needs of an end user, customer, installer, and the like.

The fibrous layers, the wicking layers, the surface layers, or a combination thereof may be directly attached to one another. One or more layers may be attached to each other by a laminating process. The one or more layers may then be supplied as a roll or a sheet of the laminated product. The one or more layers, therefore, may be attached to each other prior to any additional shaping or molding steps. The one or more layers may include a thermoplastic component (e.g., binder or fibers) that melt and bond to an adjacent surface upon exposure to heat. One or more layers may be attached to each other with an adhesive layer. The layers forming a layered material may be attached to an additional layered material. For example, a first layered material may be directly attached to a second layered material (e.g., by one or more adhesive layers) to form a layered material assembly. The layered material assembly may include more than two layered materials. The adhesive layer may be an adhesive. The adhesive may be a powder or may be applied in strips, sheets, or as a liquid or paste. The adhesive layer may extend along a surface of the fibrous layers, the wicking layers, the surface layers, or a combination thereof, to substantially cover the surface. The adhesive layer may be applied to a portion of the surface of the fibrous layers, the wicking layers, the surface layers, or a combination thereof. The adhesive layer may be applied in a pattern (e.g., dots of adhesive applied to the surface). The adhesive layer may be applied in a uniform thickness. The adhesive layer may have varying thickness. The adhesive layer may be a single layer (e.g., a single adhesive). The adhesive layer may be multiple layers (e.g., an adhesive layer and a thermoplastic fiber layer). The adhesive layer may be a single layer of blended materials (e.g., an adhesive and thermoplastic fibers are blended in a single layer).

The layers may be directly attached to each other via other processes, such as by sewing, entanglement of fibers between layers, sealing, or other methods. The edges of the layers may be sewn together. One or more layers may be sealed at the edges. For example, the outer layers (e.g., the wicking layers) may be sealed at the edges to encapsulate the interior layers, such as one or more fibrous layers. The layers may be heated and/or compressed to seal all of the layers together. A double die system may be used, where the central portion of each die is insulated so as not to burn or melt the body of the material, and the edges of the dies are heated and pinched together such that the edges are sealed and the body of the material remains lofted. For example, heated pinch edge sealing may bond the layers together. The thickness at this pinched edge may be about 3 mm or less, about 2 mm or less, or about 1 mm or less and greater than 0 mm. One or more layers or one or more edges may be ultrasonically sealed. The edge may be trimmed or cut after heating, compressing, pinching, sealing, the like, or combination thereof.

One of more of the layers of the layered material may have hydrophobic properties. One or more of the layers of the layered material may have hydrophilic properties. Entire layers may be hydrophobic or hydrophilic. A layer may have both hydrophobic and hydrophilic properties. For example, a layer may be formed from a mixture of hydrophobic fibers and hydrophilic fibers. The interfaces between layers may include one hydrophobic layer or portion abutting a hydrophilic layer or portion. The layer contacting the source of the moisture may be hydrophilic. Such layer may cause moisture to wick away from the skin and distribute the moisture over a larger area to quicken the wicking. Adjacent layers may, for example, be hydrophobic. This may assist in the drying of the material and/or resisting the uptake of moisture from the external environment. It is also possible that a hydrophobic layer or portions thereof may function to draw moisture away from a surface (e.g., the surface of the animal upon which the saddle pad is located) while absorbing little to no moisture, thereby acting to wick away the moisture. The hydrophobic layers or portions thereof may function to transfer moisture to another layer of the layered material. The hydrophilic layers or portions thereof may function to absorb moisture (e.g., from one or more hydrophobic layers or portions). Fibers within the layers may be hydrophobic. Fibers within the layers may be hydrophilic.

Fibers of one or more layers of the layered material, or one or more layers of the layered material, may exhibit antimicrobial properties. The fibers may be treated with an antimicrobial substance. For example, silver or copper may be used. Fibers may be coated with silver, copper, or a combination thereof. The antimicrobial substance may be otherwise deposited on the surface of the fibers (e.g., via sputtering, electrostatic deposition). The antimicrobial substance may be part of the fibers. For example, silver particles, copper particles, or both, may be within fibers of the one or more layers of the layered material.

The layered material disclosed exhibits breathability, which allows for an increased drying time of the material and/or increased cooling of the surface of the source of the moisture. With the ability for air to permeate the material, this decreases the drying time, thereby also decreasing the formation of mold, mildew, and/or odors. The layered material, or one or more layers thereof, may exhibit a permeability at 100 Pa of about 600 liters per square meter per second (L/m²/s) or greater, about 700 L/m²/s or greater, or about 800 L/m²/s or greater. The layered material, or one or more layers thereof, may exhibit a permeability of about 1500 L/m²/s or less, about 1200 L/m²/s or less, or about 1000 L/m²/s or less. This is a significant improvement over other materials. For example, a polyurethane memory foam at 1100 g/m² at 15 mm thickness exhibits a permeability of about 500 L/m²/s. An open cell polyurethane foam material at 600 g/m² at 20 mm thickness exhibits a permeability of less than about 100 L/m²/s. A two-layered foam formed of an ethylene vinyl acetate foam layer at 10 mm thickness and polyurethane foam layer 2 mm thickness at 1100 g/m² total exhibits no permeability.

The layered material may provide cushioning and/or pressure distribution or pressure relief while also providing moisture wicking, evaporation, thermal insulation, or the like. The layered material, or layers thereof, may exhibit resilience. Resilience may be at least in part due to the orientation of the fibers, geometry of the fibers, denier of the fibers, composition of the fibers, the like, or a combination thereof. Resilience may be measured using a standardized compression force deflection or indentation force deflection test (e.g., ASTM D3574). The desired resilience may depend upon the application within which the layered material is used. The layered material may have a resilience suitable for its intended purpose.

The layered material or one or more layers thereof (e.g., fibrous layer) may be formed to have a thickness and density selected according to the required physical, insulation, moisture absorption/resistance, and air permeability properties desired of the finished layers (and/or the layered material as a whole). The layers of the layered material may be any thickness depending on the application, location of installation, shape, fibers used, fiber geometry and/or orientation, lofting of the fibrous layers, or other factors. The density of the layers may depend, in part, on the specific gravity of any additives incorporated into the material comprising the layer (such as nonwoven material), and/or the proportion of the final material that the additives constitute. The layered material may have a varying density and/or thickness along one or more of its dimensions. Bulk density generally is a function of the specific gravity of the fibers and the porosity of the material produced from the fibers, which can be considered to represent the packing density of the fibers.

The layered material may be formed through one or more lamination techniques, or another technique capable of joining two or more layers together. The one or more layers may then be supplied as a roll or a sheet of the laminated product. The one or more layers, therefore, may be attached to each other prior to any additional shaping or molding steps.

One or more exterior layers of the layered material (e.g., the outermost layer facing a saddle, the innermost layer facing the back of the horse, or both) may have a non-flat or non-smooth surface. Variations in topography of one or more layers may be due to one or more operations performed upon the layer or the material or due to the material itself. For example, variations in topography may be formed by compression, stitching, or features of the material itself. These variations in topography may provide increased surface area exposed to air flow. For example, channels may be formed via compression, stitching, or textured material. Such channels may permit air flow between the saddle and the saddle pad. Such channels may permit air flow between the saddle pad and the body of the horse. Increased air flow may provide cooling effects, increased evaporation of moisture, or both. Stitching, localized compression, or texture of the material may allow for tunability of the material to provide desired properties, such as flexibility, fiber orientation, direction of moisture travel, density, air flow, and the like.

One or more layers (or the layered material in its entirety) may undergo one or more compression operations. Compression may be areas of localized compression, such that the entirety of the material is not compressed. Compression may be areas of localized compression such that certain areas are compressed more than others. For example, areas of localized compression may be in lines across at least a portion of the surface of the layered material or one or more layers thereof. Localized compression may be via application of heat, pressure, or both. One or more layers may be compressed during the compression operation. This may provide indentations within one or more of the layers to form channels, grooves, or other depressions. Localized compression may secure one or more layers together (e.g., via application of heat and pressure, causing one or more layers to melt and/or activate and adhere to an adjacent layer). Areas of localized compression may extend across at least a portion of the surface of one or more layers. For example, localized compression may be one or more, two or more, or a plurality of lines extending from one edge of the saddle pad to another edge. The areas of localized compression, such as lines, may begin and/or terminate at distance from the edge so it does not extend the entirety of the length or width of the surface of the layer. Lines formed via localized compression may be generally parallel to the longitudinal axis of the body of the horse. Lines formed via localized compression may be generally perpendicular to the longitudinal axis of the body of the horse. Lines formed via localized compression may be generally parallel to the direction of loops of the fibrous layer. Lines formed via localized compression may be generally perpendicular to the direction of loops of the fibrous layer. Lines formed via localized compression may be at an angle between parallel and perpendicular with the direction of loops of the fibrous layer. Lines formed via localized compression may be generally parallel to each other. Lines formed via localized compression may be an angle between parallel and perpendicular to the longitudinal axis. One or more lines formed via localized compression may be at an angle (i.e., nonparallel) relative to another line formed via localized compression. Lines formed via localized compression may intersect (e.g., forming diamonds, triangles, squares, or other polygonal shapes). Other shapes are also contemplated via localized compression, such as a zig zag pattern, dashes, spots, or the like. The number and configuration of areas of localized compression may be selected to tune the performance of the material. The configuration of areas of localized compression may be selected to provide a desired flexibility to the material in certain areas. The areas of localized compression may be generally evenly distributed over the area of the layer or layers. The areas of localized compression may be unevenly distributed, such that certain areas have more areas of localized compression. This may act to increase the density at certain areas of the layered material, increase air flow at certain areas of the material, impact flexibility at certain areas of the layered material, or a combination thereof.

Stitching may be performed instead of or in addition to localized compression. Stitching may have the same or similar functions as would providing localized compression. Stitching may act to secure two or more layers together. The stitching may extend through one or more of the layers of the layered material. Stitching may extend through the entirety of the layered material. Stitching may extend partially through the layered material. Stitching may be visible on one or both outermost surfaces of the layered material. For example, stitching may be in lines across at least a portion of the surface of the layered material or one or more layers thereof. Stitching may also act to compress one or more layers in the areas of the stitching. The stitches within one or more of the layers may form channels, grooves, or other depressions. Stitching may extend across at least a portion of the surface of one or more layers. For example, stitching may form one or more, two or more, or a plurality of lines extending from one edge of the saddle pad to another edge. The number and configuration of stitches or lines formed via stitching may be selected to tune the performance of the material. The configuration of stitches may be selected to provide a desired flexibility to the material in certain areas. The stitches may be generally evenly distributed over the area of the layer or layers. The stitches may be unevenly distributed, such that certain areas have more areas of stitching than others. This may act to increase the density at certain areas of the layered material, increase air flow at certain areas of the material, impact flexibility at certain areas of the layered material, or a combination thereof. The stitching and/or lines may begin and/or terminate at distance from the edge so it does not extend the entirety of the length or width of the surface of the layer or does not extend all the way to the edge of the material. Lines formed via stitching may be generally parallel to the longitudinal axis of the body of the horse. Lines formed via stitching may be generally perpendicular to the longitudinal axis of the body of the horse. Lines formed via stitching may be generally parallel to the direction of loops of the fibrous layer. Lines formed via stitching may be generally perpendicular to the direction of loops of the fibrous layer. Lines formed via stitching may be at an angle between parallel and perpendicular with the direction of loops of the fibrous layer. Lines formed via stitching may be generally parallel to each other. Lines formed via stitching may be an angle between parallel and perpendicular to the longitudinal axis. One or more lines formed stitching may be at an angle (i.e., nonparallel) relative to another line formed via stitching. Lines formed via stitching may intersect (e.g., forming diamonds, triangles, squares, or other polygonal shapes). Other shapes are also contemplated via stitching, such as a zig zag pattern, curved patterns, dashes, spots, or the like.

The layered material may have one or more otherwise textured surfaces (e.g., a plurality of ribs, cords, or wales), raised surfaces, or voids in or across the material. The texture may create channels or undulations in a surface of the material. The texture may provide projections as opposed to or in addition to indentations. The direction of the texture, ribs, cords, wales, or the like may extend generally parallel to the longitudinal axis of the saddle pad (where the longitudinal axis extends in the direction of the longest dimension of the saddle pad when laid flat), generally perpendicular to the longitudinal axis of the saddle pad, or any direction therebetween. The direction of texture, ribs, cords, wales, or the like may extend generally parallel to the longitudinal axis of the body of the horse (where the longitudinal axis extends generally through the body of the horse or generally parallel to the ground), generally perpendicular to the longitudinal axis of the body of the horse, or any direction therebetween. The direction of texture, ribs, cords, wales, or the like may extend generally parallel to the direction of loops of the fibrous layer (where the direction of loops is parallel to a line extending across an entire peak or valley or a crest or trough of a loop), generally perpendicular to the direction of loops of the fibrous layer, or any direction therebetween. The texture, ribs, cords, wales, or the like may extend through the entirety of the thickness of the layered material. The texture, ribs, cords, wales, or the like may extend only partially though the thickness of the layered material or may only be present on or in a single layer of the material. The texture, ribs, cords, wales, or the like may be generally evenly distributed across the entire surface of the layer or layers. The texture, ribs, cords, wales, or the like may be concentrated in certain areas or may have a non-even distribution. The distribution may increase air flow at certain areas of the material, impact flexibility at certain areas of the layered material, or a combination thereof. Moisture absorption, moisture resistance, insulation, or a combination thereof of the layered material (and/or its layers) may be impacted by the shape of the layered material. The layered material, or one or more of its layers, may be generally flat. The layered material, or one of its layers, may be supplied as a sheet. The layered material or one or more of its layers may be supplied in a roll. One or more layers of the layered material may be laminated, sewn, or otherwise attached together (e.g., to supply the layered material as a sheet or roll and/or prior to any additional shaping or molding step). The finished layered material may be fabricated into cut-to-print two-dimensional flat parts depending on the desired application. The layered material may be formed into any shape. For example, the layered material may be molded (e.g., into a three-dimensional shape) to generally match a desired shape. The finished layered material may be molded-to-print into a three-dimensional shape for a desired application.

Through and between any of the layers, moisture may travel in any direction. Moisture may move vertically in the thickness direction. Moisture may move in the length and/or width direction. Moisture may travel at any angle between vertical and horizontal, relative to the thickness direction. Moisture may travel at any angle between the length direction and the width direction relative to the longitudinal axis of the layered material. Moisture may travel to areas having less moisture present (e.g., areas at or near an area of air flow). Moisture may travel toward an area not covered by the saddle, for example. Moisture may travel generally linearly. Moisture may travel in a non-linear direction or in multiple directions.

Moisture may travel across and/or along the fibers of one or more fibrous layers. Moisture may travel in the direction of the fibers. Moisture may travel in the thickness direction in areas between loops of the lapped structure. Moisture may travel in the generally longitudinal direction at areas of loops of the lapped structure. Moisture may travel across loops (e.g., from one loop to an adjacent loop via fibers extending between the two).

Any of the layered materials as shown herein may have one or more facing layers one or more scrim layers, or both. For example, a facing layer (or scrim) may be positioned on a surface of a fibrous layer, facing away from the moisture transport layer. It is also contemplated that the fibrous layers, moisture transport layers, outer layers, adhesive layers, and surface layers may be configured in any combination and order.

The total thickness of the layered material may depend upon the number and thickness of the individual layers. The total thickness (e.g., thickness at a particular point, maximum thickness, or average thickness) may be about 0.5 mm or more, about 1 mm or more, or about 1.5 mm or more. The total thickness (e.g., thickness at a particular point, maximum thickness, or average thickness) may be about 40 mm or less, about 30 mm or less, about 25 mm or less, or about 17 mm or less. Some of the individual layers may be thicker than other layers. For example, the thickness of the fibrous layers may be greater than the thickness of the additional layers, such as wicking and/or facing layers (individually or combined). The total thickness of the fibrous layers may be greater than the total thickness of the facing and/or wicking layers. The thickness may vary between the same types of layers as well. For example, two fibrous layers in the layered material may have different thicknesses. The layered material may be tuned to provide desired characteristics and/or more general broad band moisture absorption/resistance by adjusting the specific air flow resistance and/or the thickness of any or all of the layers.

The thickness of each individual layer may depend upon the desired properties of each layer, the desired properties of the material as a whole, the interaction between layers of the material, or a combination thereof. The thickness (e.g., thickness at a particular point, maximum thickness, or average thickness) of the fibrous layer may be about 0.5 mm or more, about 1 mm or more, or about 1.5 mm or more. The thickness (e.g., thickness at a particular point, maximum thickness, or average thickness) of the fibrous layer may be about 40 mm or less, about 30 mm or less, about 25 mm or less, or about 15 mm or less.

The material, or one or more layers thereof, may have a generally uniform thickness. The material, or one or more layers thereof, may have a generally uniform thickness prior to any shaping steps (e.g., molding or thermoforming). The material, or one or more layers thereof, may have a variable thickness. The material, or one or more layers thereof, may have a variable thickness as a result of one or more shaping procedures, one or more thinned areas, one or more compressed areas, or the like. The edges of the material may be compressed, thereby creating a lower thickness at or around at least a portion of the edge of the material. The material, or one or more layers thereof, may have a variable thickness to accommodate the shape of the animal upon which it will be positioned, the shape of the saddle, or both. For example the material may have one or more contours or cutouts to accommodate a feature of a saddle, an area of greater muscular definition on the animal, or both.

The weight of the material may depend upon the number of individual layers and/or thickness of the layers. The weight of the material may be impacted by the properties desired of the material, the conditions where the material will be used (e.g., the season or temperature where the material will be used), or both. Certain applications may require a denser material. For example, during cooler conditions, a denser or higher weight material may be desirable to provide additional insulation to the horse, to provide additional cushioning or distribution of pressure to the horse, especially as a horse tends to lose weight in the cooler (e.g., winter) months, or both. The material may have a weight of about 500 gsm or greater, about 600 gsm or greater, or about 750 gsm or greater. The material may have a weight of about 1750 gsm or less, about 1500 gsm or less, or about 1250 gsm or less. The weight may be generally variable throughout the material. The variation may occur, for example, as a result of one or more shaping procedures, one or more thinned areas, one or more areas having a density gradient, or a combination thereof.

The fibrous layer itself may have a weight of about 500 gsm or greater, about 600 gsm or greater, or about 750 gsm or greater. The material may have a weight of about 1750 gsm or less, about 1500 gsm or less, or about 1250 gsm or less. The weight may be generally uniform throughout the material. The weight may be generally variable throughout the material. The variation may occur, for example, as a result of one or more shaping procedures, one or more thinned areas, one or more areas having a density gradient, or a combination thereof.

For example, the material, or one or more layers thereof (e.g., the fibrous layer), may have a thickness of about 15 mm or greater and a weight of about 600 gsm or greater. The material may have a thickness of about 30 mm or less and a weight of about 1500 gsm or less. As another example, the material, or one or more layers thereof (e.g., the fibrous layer), may be about 25 mm thick with a weight of about 1250 gsm.

The layered material may include one or more features that allow the saddle pad to be secured to a horse. The layered material may include one or more attachment features that allow the layered material to be secured to a saddle, secured to another portion of the saddle pad (e.g., within a pocket of the saddle pad), or both. The layered material may be removably secured. The layered material may be repositionable. The layered material may be interchangeable. For example, a thicker or denser layered material may be desirable during colder months, and a thinner or lighter layered material may be desirable during cooler months.

The attachment features may include straps, fasteners, adhesives, or other material capable of securing the layered material to its intended location (e.g., between the saddle and a horse, within a saddle pad, on the back of a horse). The attachment feature may be able to withstand the elements or conditions to which it is exposed (e.g., temperature fluctuations, movements of the animal during galloping, trotting, cantering, walking, laying down). Fasteners may include, but are not limited to, screws, nails, pins, bolts, friction-fit fasteners, snaps, hook and eye fasteners, Velcro, zippers, clamps, the like, or a combination thereof. Adhesives may include any type of adhesive, such as a tape material, a peel-and-stick adhesive, a pressure sensitive adhesive, a hot melt adhesive, the like, or a combination thereof. The layered material may include one or more fasteners or adhesives to join portions of the layered material to another substrate. The layered material may include a pressure sensitive adhesive (PSA) to adhere the layered material to itself or to another surface.

The material as described herein may include printing such as logos, washing instructions, sizing information, or the like. Preferably, fabric printing methods that do not plug pores of the fabric, such as sublimation printing, may be employed, so functionality of the fabric is not impacted.

Any of the materials described herein may be combined with other materials described herein (e.g., in the same layer or in different layers of the layered material). The layers may be formed from different materials. Some layers, or all of the layers, may be formed from the same materials, or may include common materials or fibers. The type of materials forming the layers, order of the layers, number of layers, positioning of layers, thickness of layers, or a combination thereof, may be chosen based on the desired properties of each material (e.g., wicking properties, cooling properties, insulative properties, and the like), the desired air flow resistive properties of the material as a whole, the desired weight, density and/or thickness of the material, the desired flexibility of the material (or locations of controlled flexibility), or a combination thereof. The layers may be selected to provide varying orientations of fibers.

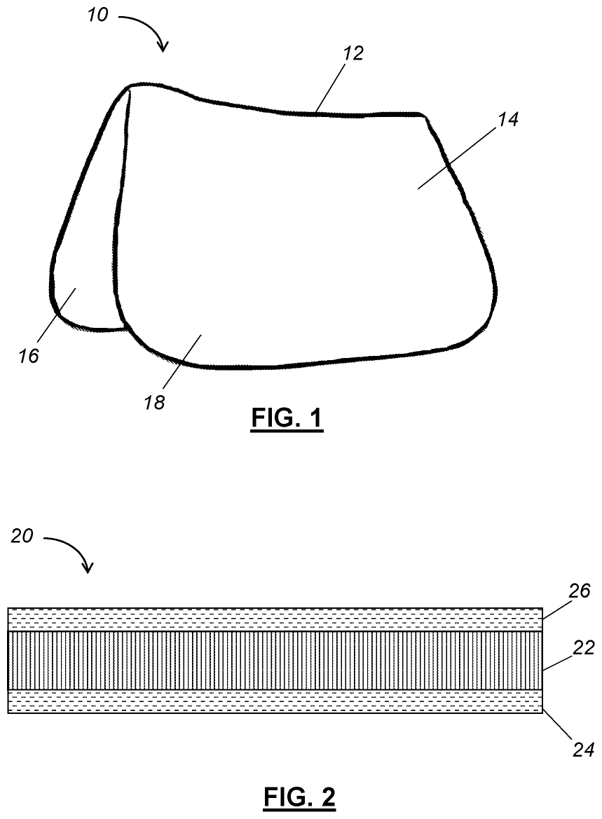

Turning now to the figures, FIG. 1 illustrates an exemplary saddle pad 10 in accordance with the present teachings. The exemplary saddle pad 10, or portions thereof, may be formed from an absorbing article 20, as shown in FIG. 2. The saddle pad 10 has a top 12 adapted to be located along the top of the animal's back and two downwardly extending flaps 14 adapted to flank the body of the animal. The saddle pad 10 has an interior 16 adapted to contact the body of the animal and an exterior 18 adapted to contact the saddle (not shown) or face away from the animal.

FIG. 2 illustrates a cross section of an absorbing article 20, where absorbing refers to absorbing moisture, shock or impact, or both, in accordance with the present teachings. The absorbing article 20 includes a fibrous layer 22 sandwiched between two facing layers. One or more of the facing layers may be a wicking layer. It is contemplated that one or both of the facing and/or wicking layers may be omitted. An interior layer 24, which may or may not be a wicking layer, is adapted to contact a source of moisture, such as the back of a horse (e.g., the interior 16 of the saddle pad 10 of FIG. 1). An optional exterior layer 26, which may or may not be a wicking layer, is located on the opposing side of the fibrous layer 22 and is adapted to contact a saddle or be exposed.

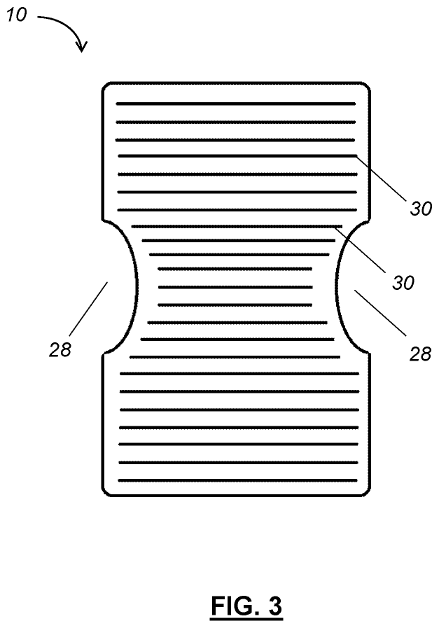

FIG. 3 illustrates an exemplary saddle pad 10 in accordance with the present teachings. The saddle pad 10 is shown as a generally flat article, prior to draping over a horse. The saddle pad 10 has a cutout or contour 28 located along each long edge. The cutouts or contours 28 are generally centrally located along the long edges. The areas of the cutouts or contours as shown are to be generally positioned in an area of the back of a horse, though other locations of cutouts or contours are also contemplated. The cutouts may allow the saddle pad 10 to lay flat when not in use and to drape over a horse without wrinkling or bunching of excess material when in use.

The saddle pad 10 includes a plurality of channels 30. Channels may be formed via stitches, seams, areas of localized compression, or within the material itself (e.g., via ribs, cords, or wales). As shown, the channels 30 would run generally parallel to the length of the back of the horse when in use.

It is contemplated that the channels may have another arrangement or configuration. The channels may be located on one or both sides of the pad. Channels, such as those formed via stitches or a seam, may extend through the entirety of the thickness of the saddle pad. Channels, such as those formed by stitches or a seam, may extend only partially through the thickness of the saddle pad. Stitches, a seam, or an area of localized compression may have a generally complementary stitch, seam, or area of localized compression on the opposing side of the saddle pad. Stitches, seams, or areas of localized compression may be located in different areas on opposing sides of the saddle pad.

Any of the layered materials as shown herein may have one or more facing layers one or more scrim layers, or both. For example, a facing layer (or scrim) may be positioned on a surface of a fibrous layer, facing away from the moisture transport layer. It is also contemplated that the fibrous layers, moisture transport layers, outer layers, adhesive layers, and surface layers may be configured in any combination and order

Any of the materials described herein may be combined with other materials described herein (e.g., in the same layer or in different layers of the layered material). The layers may be formed from different materials. Some layers, or all of the layers, may be formed from the same materials, or may include common materials or fibers. The type of materials forming the layers, order of the layers, number of layers, positioning of layers, thickness of layers, or a combination thereof, may be chosen based on the desired properties of each material (e.g., wicking properties, cooling properties, insulative properties, and the like), the desired air flow resistive properties of the material as a whole, the desired weight, density and/or thickness of the material, the desired flexibility of the material (or locations of controlled flexibility), or a combination thereof. The layers may be selected to provide varying orientations of fibers.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32, etc. are expressly enumerated in this specification. For values which are less than one, one unit is considered to be 0.0001, 0.001, 0.01, or 0.1 as appropriate. These are only examples of what is specifically intended and all possible combinations of numerical values between the lowest value, and the highest value enumerated are to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

### ELEMENT LIST

| | |
|---|---|
| 10 | Saddle pad |
| 12 | Top |
| 14 | Flap |
| 16 | Interior |
| 18 | Exterior |
| 20 | Absorbing article |
| 22 | Fibrous layer |
| 24 | Interior layer |
| 26 | Exterior layer |
| 28 | Cutouts or contours |
| 30 | Channel |

1. An article comprising:
an interior layer;
an exterior layer; and
a fibrous layer having generally vertically oriented fibers prior to any compression operation;
wherein the article absorbs and/or wicks away perspiration;
wherein the article is a breathable material;
wherein the article provides cushioning and/or pressure distribution; and
wherein the article is adapted to be positioned between a rideable animal and a saddle;
wherein the interior layer is adapted to contact a source of moisture and/or the rideable animal; and
wherein the article is a saddle pad or part of a saddle pad.

2. (canceled)

3. (canceled)

4. The article of claim 1, wherein the fibrous layer is sandwiched between the interior layer and the exterior layer.

5. (canceled)

6. (canceled)

7. (canceled)

8. The article of claim 1, wherein the interior layer is a wicking layer.

9. The article of claim 1, wherein the exterior layer is a wicking layer.

10. The article of claim 1, wherein the article has one or more channels across at least a portion of the article to provide increased air flow between the article and a saddle, the article and the rideable animal, or both.

11. (canceled)

12. The article of claim 1, wherein edges of the article are compressed and heat sealed.

13. The article of claim 1, wherein the edges of the interior layer and exterior layer are sealed to encapsulate the fibrous layer.

14. The article of claim 1, wherein the fibrous layer has a gradient density structure, wherein through the thickness, the density increases from one surface to the opposing surface.

15. The article of claim 14, wherein the fibrous layer has a greater density at a surface facing away from the wearer to increase moisture evaporation rate at the surface.

16. The article of claim 1, wherein the fibrous layer is formed by a vertical lapping process.

17. The article of claim 1, wherein the fibrous layer is formed by an air laying process.

18. The article of claim 1, wherein the article or one or more layers thereof has a weight of about 600 gsm or greater and about 1500 gsm or less.

19. (canceled)

20. The article of claim 1, wherein the article or one or more layers thereof has a thickness of about 15 mm or greater and about 30 mm or less.

21. (canceled)

22. The article of claim 1, wherein the article or one or more layers thereof is thermoformable to allow the article to be formed into a desired shape.

23. (canceled)

24. The article of claim 1, wherein the article is washable without losing shape, resilience, wicking properties, drying properties antimicrobial properties, or a combination thereof.

25. The article of claim 1, wherein the article exhibits antimicrobial characteristics, antifungal characteristics, or both.

26. (canceled)

27. The article of claim 1, wherein the article is mold or mildew resistant.

28. (canceled)

29. (canceled)

30. (canceled)

31. The article of claim 1, wherein the article comprises two or more layers that are laminated together to form a laminated product prior to any additional shaping or molding steps.

32. The article of claim 1, wherein the article includes one or more cutouts or contours to allow the article to be positioned on the rideable animal without wrinkling or bunching of excess material.

33. (canceled)

34. The article of claim 1, wherein the fibrous layer is the interior layer and/or the exterior layer.
